(19) United States
(12) Patent Application Publication
(10) Pub. No.: US 2011/0123731 A1
(43) Pub. Date: May 26, 2011

(54) DECORATIVE MEMBER, PARTICULARLY INTENDED TO BE USED AS AN EMBLEM FOR A MOTOR-VEHICLE, AND METHOD FOR MANUFACTURING THE SAME

(76) Inventors: Paolo Zanini, Arona ( Novara) (IT); Mario Franzino, Milano (IT)

(21) Appl. No.: 12/953,079

(22) Filed: Nov. 23, 2010

(30) Foreign Application Priority Data
Nov. 25, 2009 (IT) TO2009A000912

(51) Int. Cl. B60R 13/00; B23P 17/00

(52) U.S. Cl. 428/31; 29/527.2

(57) ABSTRACT

A decorative member, particularly to be used as an emblem on a motor vehicle, comprises a first body of transparent plastic material having a front face and a substantially flat rear face, an image formed by ink-jet printing at a printing zone of the rear face, and a generally flat second body applied to the rear face of the first body. The size of the printing zone of the first body is substantially smaller than the rear face, and the first body and the second body are connected to each other at a connecting strip encircling the printing zone, which strip defines a tight seal, so that the image is enclosed in a chamber sealingly closed with respect to the outer environment.

### BACKGROUND OF THE INVENTION

The present invention refers in general to decorative members, for example usable as emblems in order to represent images, symbols or trademarks, and particularly intended to be applied on a motor vehicle in order to increase its aesthetic value or to allow the manufacturer to be identified.

In particular, the invention relates to a decorative member, particularly intended to be used as an emblem for a motor vehicle, comprising a first body of transparent plastic material having a front face and a substantially flat rear face, an image formed by ink-jet printing at a printing zone of the rear face, and a generally flat second body applied to the rear face of the first body.

A member of this type is known from JP-A-2004-380300 and from CA-2 568 736. In particular, JP-A-2004-380300 discloses a DVD (Digital Video Disc) having a first transparent body, for example of polycarbonate, on one face of which an image is formed by ink-jet printing. On such an image, a white paint layer can be applied on the side opposite to the first body. The first body with the respective image is then connected, at its overall contact surface, to a second body, which is also usually transparent, to which a data support substrate is associated.

However, the member known from the above mentioned documents is not adapted to be exposed to atmospheric agents, and therefore it cannot constitute a decorative member adapted to be applied to the outside of a motor vehicle.

In fact, decorative members for motor-vehicles must be able to resist for a long time to particularly heavy atmospheric conditions, characterized by high humidity, by the presence of corrosive substances, often having a strongly acid or basic base, and to resist to high thermal excursions, usually in the range from −30° C. to +90° C. In particular, a decorative member manufactured according to the teaching of the documents mentioned above, would deteriorate in a short time owing to aggression by atmospheric agents, and the image interposed between the two bodies of plastic material, which could easily separate to each other, would be unavoidably degraded. As a result, a decorative member of this type does not comply with requirements set forth by automotive industry since, if it is used outside of the body of a motor-vehicle, it would endure an unacceptable deterioration.

### SUMMARY OF THE INVENTION

In order to overcome the drawbacks of the prior art, the subject of the invention is a decorative member having the features mentioned in the appended claims.

By virtue of this idea of solution, the decorative member of the invention has several advantages deriving directly from the fact that its image is made by a ink-jet printing process known per se. In particular, the image can have very fine details with a very wide range of colors, it can be set right by a software without requiring particular costs of investment owing to complex machinery, and it can be modified or replaced in a short time. Moreover, by virtue of the invention, the image of the decorative member is enclosed in a sealed chamber, so as to be fully isolated from the outer environment, so that it cannot endure any attack by atmospheric agents and it remains completely unchanged in the time.

The invention relates also to a method for manufacturing a decorative member, of the type defined in appended claim 7 and in the claims depending on it.

By virtue of this method, it is possible to obtain a decorative member that is highly resistant and durable in the time.

Further characteristics and advantages of the invention will be made clearer by the following detailed description, supplied as a non-limitative example and referred to the appended drawings, in which:

### BRIEF DESCRIPTION OF THE DRAWINGS

FIG. 1 is a schematic front elevational view of a decorative member according to the invention,

FIG. 2 is a schematic exploded side elevational view of the main elements of the decorative member in the condition preceding their connection, sectioned along line II-II of FIG. 1,

FIG. 3 is a view similar to FIG. 2, showing the elements of FIG. 2 reciprocally connected according to a first modification of the connection,

FIG. 4 is a perspective view of the member of FIG. 3, sectioned along line II-II of FIG. 1, and

FIG. 5 is a view similar to FIG. 3, showing the members of FIG. 2 reciprocally connected according to another modification of the connection.

### DETAILED DESCRIPTION OF THE INVENTION

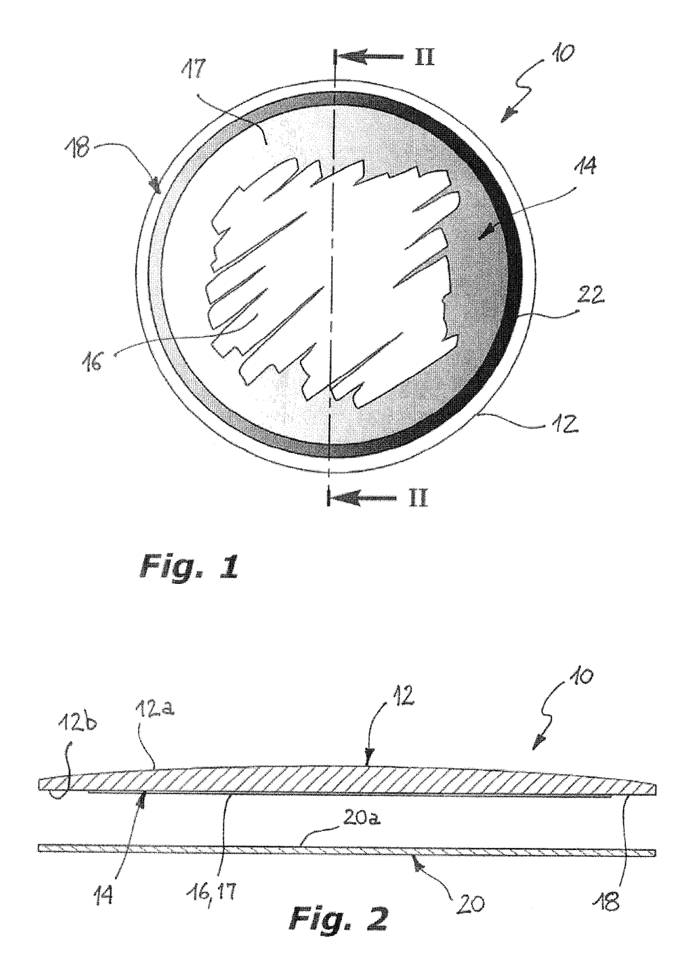

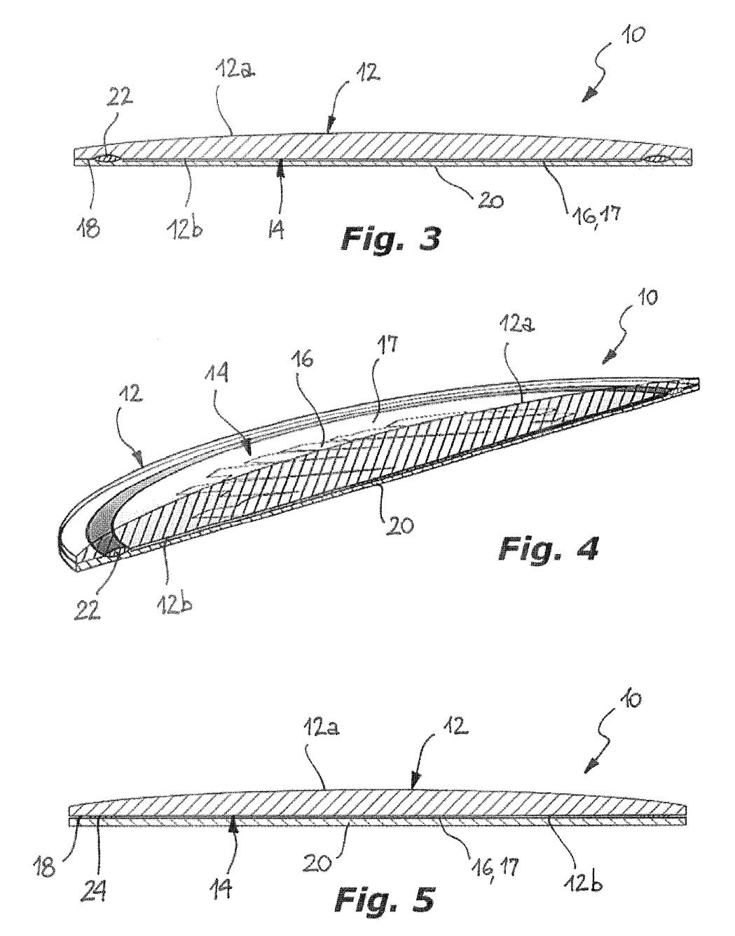

With initial reference to FIGS. 1 to 4, a decorative member according to the invention is indicated 10 in its whole. In spite of the fact the shape of the member 10 shown in the figures is circular, it could, obviously, be anyone.

The emblem 10 comprises a first body 12 of a substantially rigid transparent plastic material, usually made of poly-metil-meth-acrylate (PMMA) or of polycarbonate (PC), typically formed as a result of a molding process, for example of the injection type.

The body 12 has a front face 12a intended to face the outside, in the use, and therefore an observer, and a rear face 12b opposite to the face 12a.

The front face 12a is smooth and preferably convex, while the rear face 12b is substantially flat, so that the body 12 has the general appearance and the function of a lens. However, the rear face 12b can be provided with slight hollow prints (not shown) to define a series of ornamental or graphical patterns.

Preferably, the plastic material used for making the body 12 incorporates a UV rays screening agent, in order to carry out a protective action towards aggressive action of solar radiation, for the layers below it. This screening agent may consist of a substance belonging to benzotriazol family. In particular, an effective UV rays screening action can be obtained by adding to the plastic material of the body 12 about 2.5% in weight of a concentrated masterbatch containing 2-(2H-benzotriazol-2-yl)-p-cresol.

Conveniently, the plastic material of the body 12 is prepared, before the molding step, by subjecting it to a dehumidification process in order to remove any possible trace of humidity from the material.

Preferably, after the molding step of the body 12, it undergoes again a dehumidification process, in order to remove any possible residual humidity.

Conveniently, the rear face 12b of the body 12 may undergo a deep cleaning process by means of corona electrical discharge, or cold plasma or liquid CO₂ treatment, in order to remove possible dusts, impurities and/or traces of fat.

Thus, an image 16 is formed on the rear face 12b of the body 12 by means of the known ink-jet printing technique. The image 16 is printed at a printing zone 14 the size of which is substantially smaller than the overall extension of the face 12b, in such a manner that a free perimetral edge 18 extends outside of the printing zone 14, which edge encircles all the zone 14.

By virtue of ink-jet printing technique, the image 16 may be also very complex, may have very fine details and can be made by an almost unlimited number of colors. Moreover, it can be modified or replaced in a very short time, which would be practically impossible if other usually known printing techniques should be used, such as conventional painting, tampography, serigraphy or hot printing.

The ink of the image 16 is then dried and polymerized by means of a UV ray polymerization device known per se.

Conveniently, a usually light bottom layer 17, typically white, may be applied on the image 16 by means of ink-jet printing technique, always and only inside the printing zone 14. This bottom layer 17 constitutes a background for the image 16 and, at the same time, a coating having the function of a first protection for the image 16. Also the bottom layer 17 is preferably dried and polymerized by means of a UV ray polymerization device known per se.

The deumidification step performed before printing the image 16 at the printing zone 14, has also the function of promoting adhesion both of the ink of the image 16 and of the possible bottom layer 17, on the rear face 12b.

In order to further promote adhesion of the ink of the image 16 and of the possible bottom layer 17, the surface of the printing zone 14 may be slightly rough. For this purpose, the mold used for printing the body 12 previously undergoes a sandblasting process, at the printing zone 14 only, in such a manner that the surface of the zone 14 of the body 12 is also correspondingly rough.

Moreover, a second body 20 is prepared, the plan shape of which corresponds to that of the body 12. Also the second body 12 is made by molding, typically by injection molding, a substantially rigid plastic material, such as poly-metil-meth-acrylate (PMMA), polycarbonate (PC) or ABS. Differently from the material of the body 12, the plastic material of the second 20 is opaque and preferably has a dark color, for example black.

Analogously to what has been described in connection with the plastic material of the body 12, also the material of the body 20 undergoes preferably a dehumidification process before the molding step, and the body 20, after having been molded, can be conveniently be treated by a dehumidification process in order to eliminate any trace of humidity.

Conveniently, the front surface 20a of the body 20, which is intended to be applied against the body 12, is subjected to a corona electrical discharge, or cold plasma, or liquid CO₂ cleaning process.

The bodies 12 and 20 are then arranged side by side, in such a manner that the image 16, formed at the printing area 14 of the face 12b, is interposed between them.

When the bodies 12 and 20 are arranged side by side, they undergo a relatively high pressure, typically comprised in the range from about 0.3 to 0.5 N/mm², in order to promote the following reciprocal connection, and for fully ejecting any air present between the printing zone 14 of the body 12 and the front surface 20a of the body 20.

According to a first modification of the invention, the bodies 12 and 20 are stably connected to each other by means of a peripheral welding, preferably carried out by laser welding, by making a welding seam 22 that extends along the free edge 18, and therefore on the outside of the printing zone 14 and, particularly, on the outside of the image 16 and of the possible bottom layer 17. In this manner, paints of the image 16 and of the layer 17 cannot interfere with connection of the bodies 12 and 20, so that connection thereof turns out to be highly reliable.

At the welding seam 22, the materials of the body 12 and of the body 20 interpenetrate by fusion and they make a kind of seal encircling the printing zone 14, so that the image 14 is enclosed in a chamber without any air that is sealingly closed with respect to the outer environment, in order to avoid any possible attack by atmospheric agents.

The welding seam 22 obtained by using laser welding technique consists of a track having a width in the range from 1 to 4 mm, and a thickness that may vary from 0.1 to 0.4 mm, depending on parameters of the process and on the shape of the member 10.

Since the the body 12 is transparent, laser welding of the bodies 12 and 20 is preferably carried out by using a laser welding head arranged on the side of the front face 12b of the body 12, which laser head emits a laser beam focused at the peripheral surface of contact of the edges of the bodies 12 and 20.

Conveniently, the decorative member 10 obtained in this manner, undergoes a thermal stress relieving process in a furnace, for example for a time of about 6 hours at 70° C. In this manner, it will be able to stand wide thermal excursions, usually in the range from −30° C. to +90° C., without suffering any appreciable deformation and therefore without deteriorations of the image 14.

A modification of the invention is schematically shown in FIG. 5, wherein the same numeral references of the previous modification have been used to indicate parts equal or similar to it. Constructive details of the bodies 12 and 20, and about realization of the image 16 as well as of the possible bottom layer 17, are the same of the previous modification, and therefore they will not be described again.

In this case, connection of the bodies 12 and 20 is obtained by means of glueing, as a result of the application of a strip 24 of adhesive material on the rear face 12b of the body 12, on the outside of the zone 14 so as to encircle it, or on a corresponding portion of the front surface 20a of the body 20.

A relatively high pressure is applied to the bodies 12 and 20 arranged side by side, the amount of which is analogous to that already described with reference to the previous modification, so as to get at the same time connection of the two bodies and ejection of any air from the chamber in which the image 16 will be enclosed.

For both the modifications described, and therefore both in the case of the welding seam 18 and in the case of the adhesive strip 24, a kind of seal is made which encircles the printing zone 14 so as to sealingly isolate it with respect to the outer environment.

The member 10 obtained in this manner can be inserted in a frame (not shown), for example of chromium plated plastic material, with the aim of hiding the edge of the decorative member in which the welding seam 18 or the strip 24 of adhesive material, respectively, is present.

1. A decorative member, particularly intended to be used as an emblem for a motor-vehicle, comprising:
a first body of transparent plastic material having a front face and a substantially flat rear face,
an image formed by ink-jet printing at a printing zone of the rear face, and
a generally flat second body applied to the rear face of the first body,
wherein the size of the printing zone of the first body is substantially smaller than its rear face, and in that the first body and the second body are connected to each other at a connecting strip that encircles the printing zone, which strip defines a tight seal, so that the image is enclosed in a chamber sealingly closed with respect to the outer environment.

2. A member according to claim 1, wherein the front face of the first body is convex, so that the first body is lens shaped.

3. A member according to claim 1, wherein the second body is an opaque body, preferably having a dark or black colour.

4. A member according to claim 1, wherein a white paint layer is applied on the side of the image opposite to the first body and within said printing zone.

5. A member according to claim 1, wherein said connecting strip consists of a welding scam.

6. A member according to claim 1, wherein said connecting strip consists of a strip of adhesive material.

7. A method for manufacturing a decorative member, particularly intended to be used as an emblem for a motor-vehicle, comprising the steps of:
providing a first body of transparent plastic material having a front face and a substantially flat rear face, as well as a second generally flat body,
forming an image using ink-jet printing within a printing zone of the rear face of the first body, and
connecting the first body and the second body to each other, said image being interposed between them, wherein the printing zone extends on an area smaller than the whole rear face of the first body, so that an edge of the first body is free from the ink of the image, and in that the step of connecting the first body and the second body is performed along a strip shaped zone extending at said free edge, in order that a tight seal encircling the printing zone is defined, so that the image is enclosed in a chamber sealingly closed with respect to the outer environment.

8. A method according to claim 7, comprising the step of applying a white paint layer on the image and/or on the printing zone.

9. A method according to claim 8, wherein said white paint layer is made by ink-jet printing.

10. A method according to claim 7, wherein connection of the first body and the second body includes the step of welding said bodies at a welding seam on the outside of said printing zone.

11. A method according to claim 10, wherein the second body is an opaque body, preferably having a dark or black colour, and in that said welding step is performed by a laser welding head working on the side of the front face of the first body.

12. A method according to claim 7, wherein connection of said bodies comprises the step of interposing a strip of adhesive material between them, on the outside of said printing zone.

13. A method according to claim 7, wherein the first and the second body arranged side by side are subjected to a high pressure, during the connection step thereof, in order to promote their connection and to eject any air from the reciprocal contact area.

14. A method according to claim 7, wherein said first body is formed by a molding step, and in that the mold used to form the first body is subjected to a sandblasting process only at the printing zone of its rear face, in such a manner that the surface of the printing zone is slightly rough in order to improving adhesion of the ink of said image and/or of said white paint layer.

15. A method according to claim 7, wherein the plastic material used for making the first and the second body is subjected to a dehumidification process, and in that both the first and the second body are subjected to a dehumidification process before forming said image.

16. A method according to claim 7, wherein a UV ray screening agent is incorporated in the plastic material used for making the first body, in order that said screening agent carries out a protective action for the ink of said image with respect to solar radiation.

17. A method according to claim 7, wherein the rear surface of the first body as well as the surface of the body intended to be arranged in contact with the first body, undergo a cleaning process using corona, cold plasma or liquid CO₂.

18. A method according to claim 7, wherein the whole decorative member is subjected to a thermal stress relieving process.
